(19) United States
(12) Patent Application Publication
(10) Pub. No.: US 2010/0140437 A1
(43) Pub. Date: Jun. 10, 2010

(54) SUCTION CUP

(76) Inventor: John Orban, Torrington, CT (US)

Correspondence Address: LAW OFFICE OF MICHAEL A. BLAKE, LLC, 95 HIGH STREET, SUITE 5, MILFORD, CT, 06460, US

(21) Appl. No.: 12/638,346

(22) Filed: Dec. 15, 2009

Related U.S. Application Data
(63) Continuation-in-part of application No. 11/846,254, filed on Aug. 28, 2007, now abandoned.

(51) Int. Cl. F16B 47/00

(52) U.S. Cl. 248/363

(57) ABSTRACT

A suction cup comprising: a convex surface; a concave surface located on an opposite side of the convex surface; a perimeter located on an outer edge of the concave surface; a concentrated pressure band located on the concave surface when the suction cup is in use; and at least one annular band of soft, resilient and sticky material located on the concave surface.

### CROSS-REFERENCES

This application is a continuation-in-part application of U.S. Ser. No. 11/846,254 to John Orban, filed Aug. 28, 2007, entitled “Suction Cup”, the contents of which are fully incorporated by reference herein.

### TECHNICAL FIELD

The present invention relates generally to suction cups and more specifically to a suction cup with a resilient ring of material.

### BACKGROUND

Suction cups have long been in use to temporarily attach one object to another. Suction cups are not to be confused with vacuum cups, which rely on a device such as a vacuum pump for maintaining a vacuum between the inner surface of the cup and the surface to which the cup is to be attached. The obvious advantage of the suction cup over the vacuum cup is the ease with which the cup may be maneuvered, applied and released. Other advantages include eliminating the need for the vacuum-producing apparatus, thereby reducing cost of manufacture and operation.

A major problem has plagued users of suction cups from the beginning, and that is early release. Early release occurs when a suction cup detaches from a surface earlier than intended. This is especially true if the surface is textured and/or has a surface roughness greater than glass. Many attempts have been made to address this problem, including adding an external biasing device to the suction cup to urge its center away from the surface, using a multiple layer suction holder that applies pressure to the outside perimeter of a softer bottom shell, using a suction cup with a resilient gasket in a molded channel, using a suction cup with a non-resilient gasket, using a suction cup that is a one piece dual material cup having a soft inside surface and a harder biasing outer shell and using a sealant or vacuum grease at the interface between the cup and the surface to enhance the seal. The external biasing device applies an external biasing force to increase the strength of the vacuum within the chamber formed by the cup and the surface, thereby providing a more secure attachment.

One known suction cup device provides a suction cup device comprising a sucking body to be pressed against a surface and a resilient member superimposed above the sucking body that will tend to urge the sucking body away from the surface, which in turn results in the sucking body being more securely attached to the surface. One disadvantage of this approach is that the complexity of the device is increased, thereby increasing both manufacturing costs and likelihood of failure. Another disadvantage is that, while the biasing force increases the strength of the vacuum in the chamber, it does nothing to change the limited “seal zone” of the contact surface. Another known suction cup device uses a flowable, liquid adhesive in order to assist attaching the suction cup to a surface. However, such a flowable liquid adhesive generally can only be used one time, or very few additional times, before the liquid adhesive loses its adhesive properties or becomes depleted. Another disadvantage to using a flowable liquid adhesive is that the suction cup will not be able to hold much weight until the adhesive fully cures. This could take several minutes to hours. Also, if mounted on a vertical surface the liquid adhesive could act like a lubricant and cause the suction cup to slide down the mounting surface if weight were applied too soon. Still another disadvantage of using a flowable adhesive is that the adhesive will have a shelf life (weeks or months) and must be used for mounting before the shelf life expires. If not, then the liquid adhesive may solidify or thickened to the point where it will not function/adhere properly.

Therefore a suction cup that overcomes the above described and other disadvantages is needed.

### SUMMARY

The disclosed invention relates to a suction cup comprising: a convex surface; a concave surface located on an opposite side of the convex surface; a perimeter located on an outer edge of the concave surface; a concentrated pressure band located on the concave surface when the suction cup is in use; and at least one annular band of soft, resilient and sticky material located on the concave surface.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is perspective view of the disclosed suction cup;

FIG. 2 is a side view of the disclosed suction cup;

FIG. 3 is a bottom view of the disclosed suction cup without the annular band of material;

FIG. 4 is a side cross-sectional view of the disclosed suction with the annular band of material;

FIG. 5 is a bottom view of the disclosed suction cup with an annular band of material located at the perimeter;

FIG. 6 is a bottom view of the disclosed suction cup with an annular band of material located between the perimeter and on the edge of the concentrated pressure band;

FIG. 7 is a bottom view of the disclosed suction cup with an annular band of material located from the perimeter to just outside the concentrated pressure band;

FIG. 8 is a bottom view of the disclosed suction cup with two annular bands of material;

FIG. 9 is a bottom view of the disclosed suction cup with an elliptical annular band of material located partially on the perimeter and outside of the concentrated pressure band;

FIG. 10 is a bottom view of the disclosed suction cup from FIG. 8, with the concentrated pressure band displaced to the top portion of the cup;

FIG. 11 is a bottom view of the disclosed suction cup with an semi-elliptical annular band of material located on the perimeter toward the top of the suction cup and just outside the sealing band on the bottom of the cup;

FIG. 12 is a bottom view of the disclosed suction cup with an semi-elliptical annular band of material located on the perimeter toward the top of the suction cup and just outside the sealing band on the bottom of the cup; with the sealing band displaced;

FIG. 13 is a bottom view of the disclosed suction cup with the annular band on the outside perimeter of the suction cup;

FIG. 14 is a side view of the disclosed suction cup with the annular band on material incorporated into the design at the perimeter, similar to FIG. 5 except the band of material makes up part of the suction cups construction; and

FIG. 15 is a bottom view with the annular band of material located at the perimeter just like FIG. 5 with the addition of grippy, non-slip individual nodules as shown.

### DETAILED DESCRIPTION

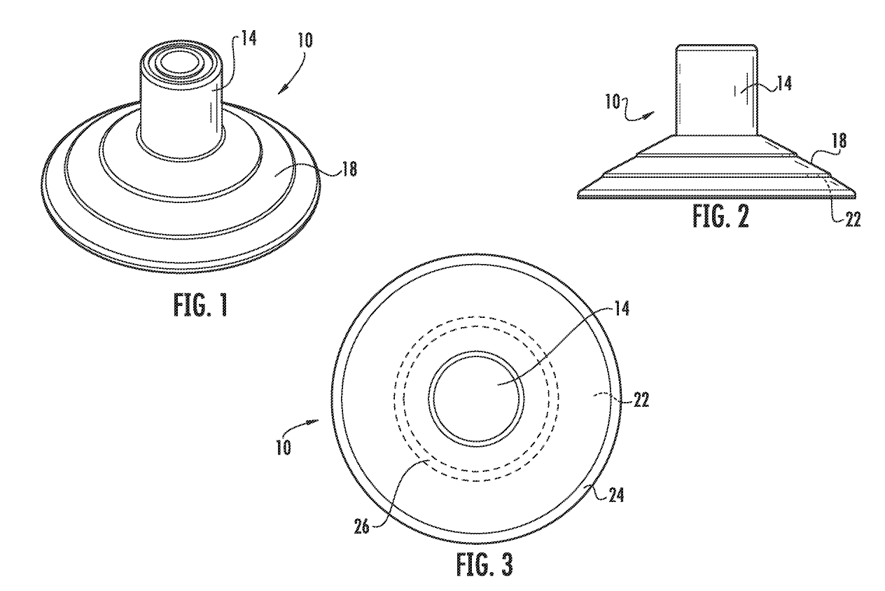

FIG. 1 is a perspective view of a disclosed suction cup 10. This cup 10 has a post 14 and a convex surface 18. On the opposite side of the convex surface 18 is the concave surface 22 (not visible in this view) of the cup 10. FIG. 2 shows a side view of the disclosed suction cup. The post 14 and convex surface 18 are also visible in this view. FIG. 3 is a bottom view of the suction cup 10. The post 14 is shown in the center of the cup 10. Although, suction cups with posts are shown in the figures, one of ordinary skill in the art will recognize that other suction cup styles will be suitable for this invention, including, but not limited to suction cups with Mushroom Heads, suction cups with Top Pilot Hole Heads; suction cups with Side Pilot Hole Heads; suction cups with Hooks; suction cups with Clamps, suction cups with Studs & Nuts; and suction cups with loops.

Referring still to FIG. 3, a concentrated pressure band 26 is shown (identified by the dashed lines) on the cup 10 in use. To mount a suction cup one simply presses the cup flat against the mounting surface displacing the air that was under the cup. A vacuum chamber forms between the cup and the mounting surface. Due to the low pressure of the vacuum chamber, atmospheric pressure holds the suction cup in place. There is a concentrated pressure band 26 that forms the main seal of the cup. The area inside this concentrated pressure band is the vacuum chamber. This concentrated pressure band 26 forms due to the fact that the cup is trying to push up away from the mounting surface, and atmospheric pressure is pushing on the exterior of the cup towards the mounting surface. The phrase “suction cup in use” shall refer to when the suction cup has been attached to a surface via the attachment properties of the suction cup.

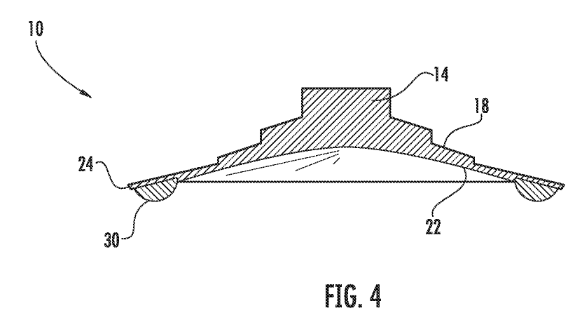

FIG. 4 shows a side cross-sectional of the cup 10, but with the annular band of material 30 located at or near the perimeter 24 of the cup. The cross-sectional shape of the annular band of material is semi-circular in this view, but may be of any suitable shape so long as it extends from the concave surface 22.

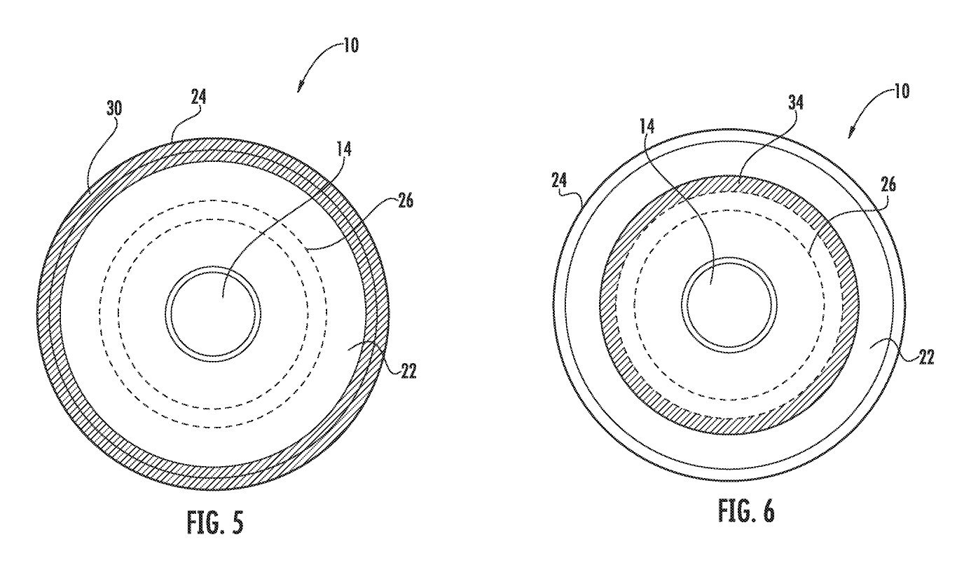

FIG. 5 shows a bottom view of the cup 10 in use. In this view, an annular band of material 30 is shown located on the perimeter 24 of the concave surface 22. The band of material 30 may be made out of a urethane, silicone, hot melt, closed cell foam, or some other material that is very soft, resilient and sticky. The hardness of a material may be measured by an instrument called a durometer. Different shore scales are used to specify relative hardness of materials. The Shore A scale is used for soft materials and Shore OOO is used for very soft materials. The Shore OOO measures materials like silicone or polyurethane gels that are as soft as human fat tissue for example. These materials may work as a perimeter seal on the suction cup. The material on the disclosed suction cup has a durometer range of about 35 Shore OOO to about 50 Shore A. The higher on the scale the harder the material. In one embodiment, the band of material may have a durometer of 8 Shore A. The band of material should produce at least at about 0.1 lb/in 90° peel strength to the mounting surface. The thickness of the band of material may be about 0.005 inches to about 0.5 inches, and preferably about 0.010 inches to about 0.25 inches.

FIG. 6 shows another embodiment of the disclosed suction cup 10 in use. In this bottom view of a suction cup 10, an annular band of material 34 is shown located on the concave surface 22 just outside the concentrated pressure band 26.

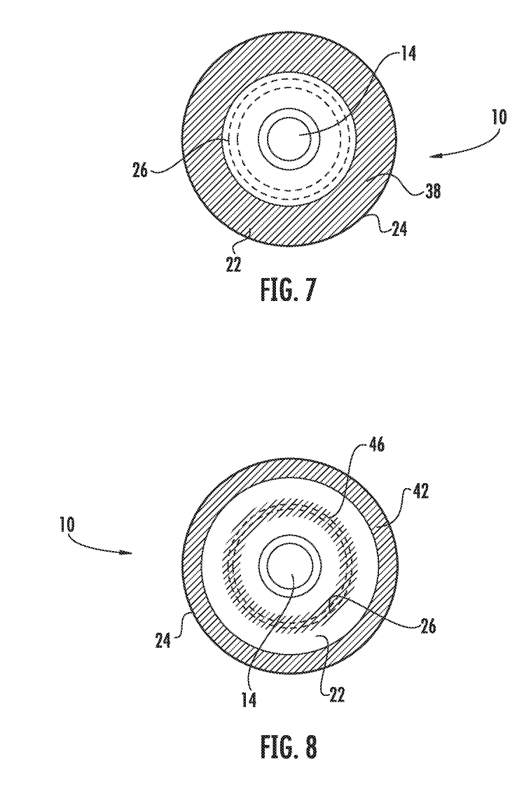

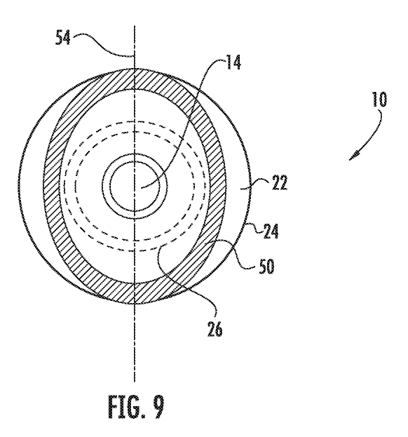

FIG. 7 shows another embodiment of the disclosed suction cup 10 in use. In this bottom view of a suction cup 10, an annular band of material 38 is shown located on the concave surface 22 from the perimeter 24 of the concave surface 22 to just outside the concentrated pressure band 26.

FIG. 8 shows another embodiment of the disclosed suction cup 10 in use. In this bottom view of a suction cup 10, there are two bands of material 42, 46 located on the concave surface 22 on the perimeter 24 of the concave surface 22 to just inside the concentrated pressure band 26.

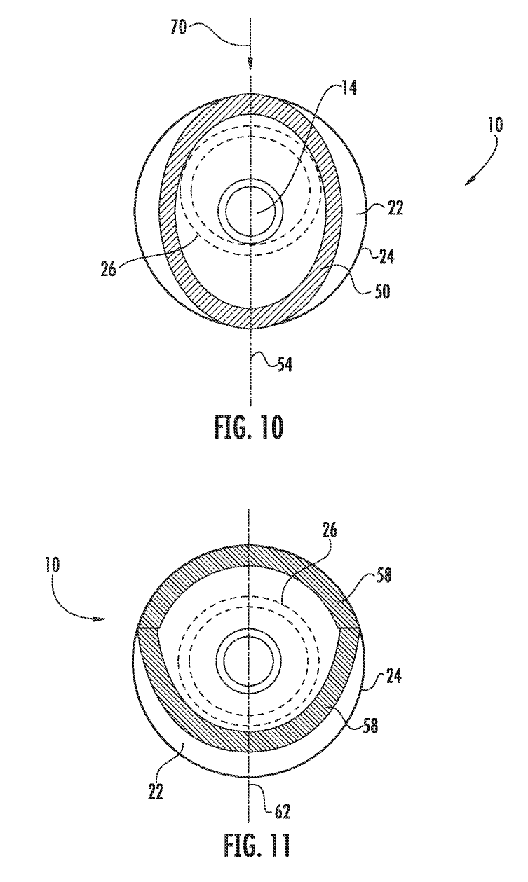

FIG. 9 shows another embodiment of the disclosed suction cup 10 in use. In this bottom view of a suction cup 10, there is an annular band of material 50 located partially at the perimeter 24 to just outside the concentrated pressure band 26. However, in this embodiment, the band of material 50 is configured into an elliptical annular shape. When this suction cup 10 is used, the long axis 54 of the band of material 50 will be oriented to be parallel to the direction of the force exerted on the suction cup. Such a force may include, but is not limited to gravity, tension from a spring, pushing from a compression spring, tension from a bungee cord, etc. The reason why the long axis 54 is orientated to be parallel to the force exerted on the suction cup 10, is because it is a recently discovered phenomena that the concentrated pressure band 26 gets displaced when a strong enough force is exerted on a suction cup 10. FIG. 10 shows a suction cup 10 that has had a force applied to the post 14 in a downward direction 70 while in use. The concentrated pressure band 26 is displaced toward the top section due to the force acting on the suction cup 10. Thus, if the band of material 50 is configured to be in an elliptical shape, then the concentrated pressure band 26 and the band of material 50 will not interfere with each other. Such interference may cause the suction cup 10 to lose suction.

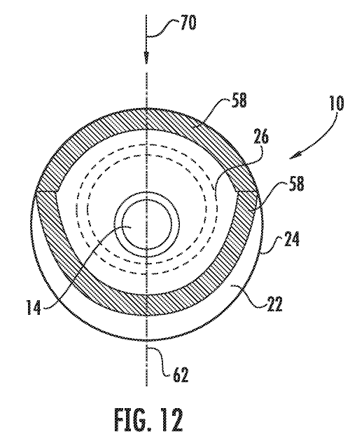

FIG. 11 shows another embodiment of the disclosed suction cup 10 in use. In this bottom view of a suction cup 10, there is an annular band of material 58 located between the perimeter 24 and the concentrated pressure band 26. Similar to the embodiment shown in FIG. 9, the band of material 58 is configured into a semi-elliptical annular shape. When this suction cup 10 is in use, the long axis 62 of the band of material 58 will be oriented to be parallel to the direction of the force exerted on the suction cup. Such a force may include, but is not limited to gravity, tension from a spring, pushing from a compression spring, tension from a bungee cord, etc. FIG. 12 shows the suction cup 10 of FIG. 11 in use, after a force has been applied to the post 14 in a downward direction 70. The concentrated pressure band 26 has displaced toward the top of the suction cup. However, because the band of material 58 is also in a semi-elliptical shape, the concentrated pressure band 26 does not interfere with the band of material 58, which thus prevents a possible loss of suction of the suction cup 10 due to such interference.

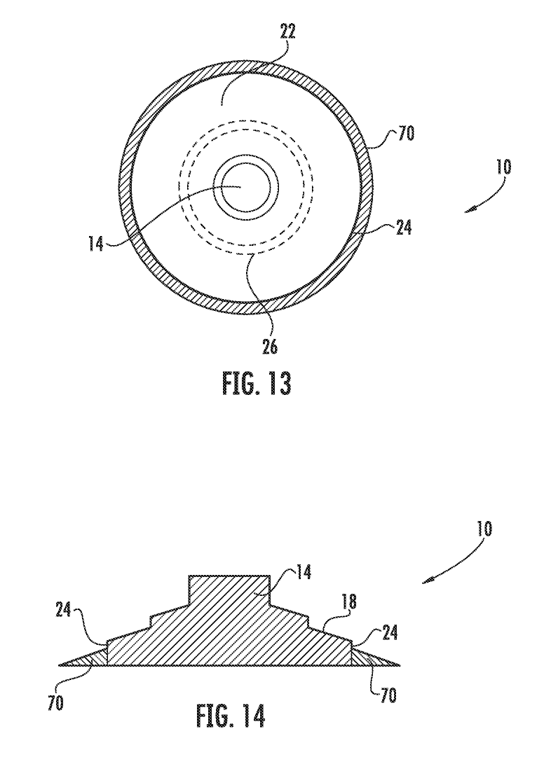

FIG. 13 is another embodiment with the annular band of material on the exterior outer edge of the suction cup in use.

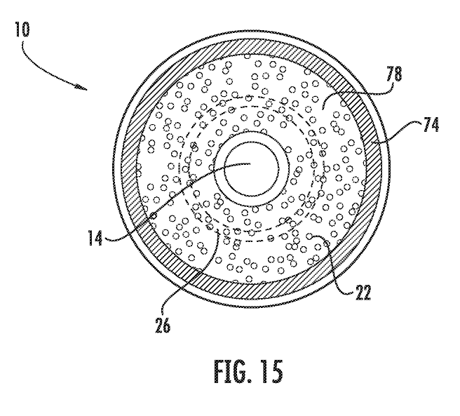

FIG. 14 is another embodiment showing the annular band incorporated into the construction of the suction cup.

FIG. 15 shows another embodiment of the suction cup 10 in use where there is an annular band of material 74 just like FIG. 5 with the addition of a plurality of grippy non-slip individual nodules 78, or a grippy non-slip coating or film on the concave inside surface. The grippy non-slip nodules 78 inhibit the sliding of the cup 10 when a force is applied to the post parallel to the mounting surface. The nodules 78, film, or coating may be made out of the following non-limiting materials: rubber, urethane, silicone, PVC or similar soft, grippy, non-slip material.

The concentrated pressure band 26 may be located between 50-80% of the diameter of a 3½ inch mounted suction cup. The concentrated pressure bands were measured to be about 1/16 inch to about 3/16 inch in width on a 3½ inch mounted suction cup. However, the disclosed invention encompasses suction cups that have diameters greater and less than 3½ inches.

The band of material may be created by dispensing a liquid adhesive or sealant onto a concave surface 22 of a suction cup 10, and then curing that material in place. The band of material may be a radiation cured material or a hot melt or some other material that is very resilient and sticky. Another method of installing an annular band of material on a suction cup 10 is to have an annular space manufactured into the concave surface 22 of a suction cup, and simply have a slight interference fit for the band of material (which may be shaped like an O-ring gasket). The band of material may be made out of a urethane, silicone, hot melt or some other suitable material that is very soft, resilient and sticky. In a preferred embodiment, the band of material will be a solid, non-flowable material. This solid, non-flowable material will allow the disclosed suction cup 10 to be used and reused many times. Such a solid, non-flowable material will generally not lose its adhesive properties, nor will it generally be depleted upon use and reuse. The suction cups may be made out of PVC, urethane, or other suitable material.

The disclosed suction cup may be used as follows, however one of ordinary skill will recognize that the suction cup may be used in a variety of suitable ways: 1.) Press the suction cup flat against the mounting surface displacing the air that was under the cone just like a regular suction cup. 2.) While still holding the cup in place, take a finger and firmly press and slide it around the entire seal circumference. This forces the band of sealing material to conform to the surface features and the tack bonds it to the surface to form an airtight seal. 3.) To remove and reuse the cup slowly peel it from the mounting surface releasing the vacuum. Due to the band of sealing material's inherent tacky property it may be reused and mounted on another surface.

The disclosed suction cup may be manufactured as follows, however one of ordinary skill will recognize that the suction cup may be manufactured using a variety of methods: 1.)Use an existing suction cup design made from PVC or other suitable material. 2.) Mount the cup to a smooth flat fixture. This fixture will be made such that the band of sealing material region is exposed and accessible. The fixture keeps the band of sealing material region on the cup flat and level. 3.) Dispense a radiation curable, liquid sealant/adhesive with pressure sensitive adhesive properties onto the inside surface of the cup in the band of sealing material region. 4.) Cure the band of sealing material-in-place with UV, Visible light, or other form of radiation. With the proper lamp this may take only seconds. This step of curing the band of sealing material will ensure that the band of sealing material becomes generally a solid non-flowable material. 5.) Apply a release liner onto the band of sealing material to protect from contamination.

The band of sealing material may be selected from the group consisting of a UV curable polymer; a light curable polymer; a heat curable polymer; and a radiation curable polymer, that upon curing, the material is a solid non-flowable adhesive material.

The advantages of the disclosed suction cup are that the disclosed suction cup can mount to textured surfaces. The suction cup has a very resilient, low durometer, sticky, band of material located on the concave surface. When pressed against a mounting surface the compliancy of the band of material conforms to the textured surface features and the sticky exterior of the material bonds it to these features creating an air impervious barrier. This seal created by the band of material prevents air from leaking into the vacuum chamber so the cup is held in place by atmospheric pressure and the suction of the vacuum. Once mounted it performs very similar to a regular suction cup except that the sealing of the vacuum chamber is no longer dependent solely on the concentrated pressure band. The friction between the cup and the mounting surface at the concentrated pressure band along with the adhesion of the band of material prevents vertical sliding of the suction cup. The disclosed suction cup may be reused many times, since the band of sealing material is a non-flowable solid, and thus will generally not be depleted nor generally lose its adhesive properties. Another advantage, is that the non-flowable sealing material and the suction cup are ready to immediately be able to handle the recommended weight limit as soon as it is mounted. Thus, there is no need to wait for the sealing material to cure or set. Because the disclosed invention uses an already cured polymer as a sealing material, the shelf life of the non-flowable sealing material is going to be years long, instead of only weeks or months of shelf life associated with flowable sealing materials. Also, the disclosed suction cup is safer to use because one is not handling a flowable sealing material, which may get on human skin, causing a skin reaction, or staining clothes.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A suction cup comprising:
a convex surface;
a concave surface located on an opposite side of the convex surface;
a perimeter located on an outer edge of the concave surface;
a concentrated pressure band located on the concave surface when the suction cup is in use; and
at least one annular band of soft, resilient, sticky, solid, and non-flowable material located on the concave surface.

2. The suction cup of claim 1, wherein the at least one annular band of soft, resilient, sticky, solid, and non-flowable material is selected from the group consisting of a UV curable polymer; a light curable polymer; a heat curable polymer; a hot melt polymer; and a radiation curable polymer.

3. The suction cup of claim 1, wherein the annular band has a durometer of about 35 Shore OOO to about 50 Shore A.

4. The suction cup of claim 1, wherein the annular band has a tackiness that produces a 90° Peel strength of about 0.1 lb./in. to about 40 lbs./in.

5. The suction cup of claim 4, wherein the tackiness property of the annular band is immediately available for assisting in mounting of the suction cup.

6. The suction cup of claim 1, wherein the annular band of resilient and sticky material is located generally only on the perimeter.

7. The suction cup of claim 1, wherein the annular band of resilient and sticky material is located generally between the perimeter and the concentrated pressure band.

8. The suction cup of claim 1, wherein the annular band of resilient and sticky material is located generally from the perimeter to just outside the concentrated pressure band.

9. The suction cup of claim 1, wherein there is a first annular band of resilient and sticky material located on the concave surface and a second annular band of resilient and sticky material located on the concave surface.

10. The suction cup of claim 9, wherein the first annular band of resilient and sticky material is located between the perimeter and the concentrated pressure band, and wherein the second annular band of resilient and sticky material is located generally on the concentrated pressure band.

11. The suction cup of claim 1, wherein the at least one annular band of resilient and sticky material has an elliptical shape.

12. The suction cup of claim 11, wherein the at least one annular band is partially located on the perimeter, and outside of the concentrated pressure band.

13. The suction cup of claim 11, wherein the at least one annular band is located between the perimeter and the concentrated pressure band.

14. The suction cup of claim 1, further comprising:
a grippy non-slip coating located on the concave surface.

15. The suction cup of claim 1, further comprising:
a plurality of individual nodules located on the concave surface.

16. The suction cup of claim 1, wherein the annular band of soft, resilient, sticky, solid, and non-flowable material is cured.

17. The suction cup of claim 1, wherein the annular band of soft, resilient, sticky, solid, and non-flowable material requires no waiting time for setting.

18. The suction cup of claim 1, wherein the annular band of soft, resilient, sticky, solid, and non-flowable material has a shelf life of at least two years.
